(19) United States
(12) Patent Application Publication
(10) Pub. No.: US 2008/0031253 A1
(43) Pub. Date: Feb. 7, 2008

(54) Apparatus and Method for Efficiently Processing Voice Packet Data in Mobile Communication System Providing Voice Service Using Packet Network

(76) Inventors: Soeng-Hun Kim, Gyeonggi-do (KR); Gert-Jan Van Lieshout, Middlesex (GB)

Correspondence Address: Dilworth & Barrese, 333 Earle Ovington Blvd, Suite 702, Uniondale, NY, 11553, US

(21) Appl. No.: 11/597,239

(22) PCT Filed: May 13, 2005
(86) PCT No.: PCT/KR05/01412

§ 371 Date: Oct. 18, 2007

(30) Foreign Application Priority Data
May 19, 2004 (KR) 10-2004-0035754

(51) Int. Cl. H04L 12/56

(52) U.S. Cl. 370/393; 370/392

(57) ABSTRACT

Disclosed are apparatus and method for efficiently processing voice packet data in a mobile communication system providing voice service using a packet network. The method includes: receiving a voice packet from an upper layer and generating a header including information about voice packet type and information for checking of voice packet error; confirming a data field of the voice packet based on the packet type and determining an error detection range; reconstructing a voice packet including the error detection range and the header and transferring the reconstructed voice packet to a lower layer. The apparatus and method can perform decoding with proper CODEC for an erroneous voice packet, thereby improving the quality of voice communication.

### TECHNICAL FIELD

The present invention relates to an apparatus and a method for improving the quality of voice communication by efficiently processing erroneous voice packet data when a voice service is provided through a packet network in a mobile communication system.

### BACKGROUND ART

In general, mobile communication systems are developing to high speed and high quality wireless data packet communication systems these days in order to provide data services and multimedia services beyond initial voice-based services. The UMTS (universal mobile telecommunication service) system (the 3rd mobile communication terminal) employing a W-CDMA (wideband code division multiple access) scheme based on the GSM (global system for mobile communications) and the GPRS (general packet radio services) (which are European Mobile Communication Systems) can transmit a packet-based text or digitalized voice data, video and multimedia data at a high speed of at least 2 Mbps.

The 3GPP performing a standardization work for such a UMTS communication system has discussed a plan for providing VoIP (Voice over Internet protocol) communication supporting voice services through a packet network. The VoIP communication enables the provision of voice services via a packet network by using a packet communication scheme through which voice frames generated from a voice CODEC are transmitted based on the IP/UDP/RTP (Internet protocol/User Datagram Protocol/Real-time Transport Protocol.

FIG. 1 illustrates an operation of performing the VoIP by a user equipment.

The user equipment includes a CODEC 105 for converting voice into voice frames, an IP/UDP/RTP protocol layer 110 for making an IP/UDP/RTP packet using the voice frames, a PDCP (Packet Data Convergence Protocol) layer 115 for compressing the header of the IP/UDP/RTP packet, a RLC (radio link control) layer 120 for converting the IP/UDP/RTP packet in the form suitable for transmission through a wireless channel, a MAC (medium access control) layer 125 for transmitting the packet data through the wireless channel, and a physical layer (PHY) 130.

Herein, voice packet data transmitted by the user equipment 100 are delivered to an RNC 150 through the PHY layer 135 of the Node B 140. The RNC 150 including a MAC layer 155, an RLC layer 160, and a PDCP layer 165 similarly to the user equipment 100 converts the received data into an original IP/UDP/RTP packet to be transmitted to a core network (CN) 170. The IP/UDP/RTP packet is transmitted to a communication counterpart through an IP network 180. Voice data of a communication counterpart are delivered to the user equipment in the direction opposite to the above-described order.

As described above, in the 3GPP network, the header compression unit is included in packet data convergence protocol (PDCP) layers 115 and 165, and a unit for converting an IP/UDP/RTP packet into a packet in the suitable form transmitted through a wireless channel is included in radio link control (RLC) layers 120 and 160.

Hereinafter, the functions of the RLC layers will be described in more detail.

The RLC layer has an Unacknowledged Mode (UM), an Acknowledged Mode (AM), and a Transparent Mode (TM) according to operation modes. Herein, it is expected that the VoIP be processed in the RLC UM mode from among the operation modes. Hereinafter, the operation of the RLC UM will be described.

An RLC UM layer in a transmission side divides, concatenates, or pads data (i.e., RLC service data unit (RLC SDU)) received from the upper layer so as to make data having a size suitable for transmission through a wireless channel. Then, the RLC layer makes a protocol data unit (RLC PDU) by inserting division/concatenation/padding information and a sequence number and delivers the RLC PDU to the lower layer.

Accordingly, an RLC UM layer in a reception side analyzes the sequence number and the division/concatenation/padding information of the RLC PDU delivered from the lower layer and forms an RLC SDU to be delivered to the upper layer.

In addition, the operation of the RLC TM mode denotes an operation of transmitting an RLC SDU delivered from the upper layer to the lower layer as it is or delivering an RLC PDU delivered from the lower layer to the upper layer as it is.

As described above, voice data generated from a CODEC 105 in the user equipment 100 becomes a VoIP packet through the IP/UDP/RTP protocol layer 110. The header of the VoIP packet is compressed through a PDCP layer 104 suitably for transmission in a reverse direction, and the VoIP packet is reconstructed in the size suitable for wireless channel transmission through the RLC layer 103. The reconstructed VoIP packet is channel-coded in the MAC/PHY layers 125 and 130 and transmitted through a wireless channel. The RLC PDU (or Transport Block: the RLC PDU is processed in a physical layer and then the processed RLC PDU is called “Transport Block”) is channel-decoded in the PHY layer 135 of the Node B 140 and then transmitted to the RNC 150.

The RNC 150 makes a VoIP packet to be transmitted to the CN 170 using RLC PDUs. The CN 170 delivers the VoIP packet to a communication counterpart through the IP network 160 or the PSTN 190. Forward data transmission is achieved in the direction opposite to the above-described order.

In addition, communicating parties on both sides of a mobile communication system supporting the VoIP must use the same type of CODECs. For example, if communication is performed between the UMTS user equipment 100 and a common wire telephone user 165, a predetermined unit may perform the conversion function of the CODEC in both the UMTS core network and the common wire telephone network.

Also, the CODEC used in the 3GPP includes an adaptive multi rate (AMR) CODEC, and the AMR CODEC performs an error concealment operation with respect to erroneous voice data. This is because the error concealment operation can provide a superior communication quality in comparison with a case of completely stopping use of the erroneous voice data.

FIG. 2 illustrates the format of a VoIP packet transmitted through a wireless channel.

An IP/UDP/RTP header is added to voice data 225 generated from the AMR CODEC and then delivered to a PDCP layer. Herein, the AMR CODEC adds an AMR payload specific header 220 to the voice data. The AMR payload specific header 220 includes information representing if the AMR voice data corresponds to data in a silent descriptor section or real voice data. The PDCP layer includes a robust header compression (ROHC) protocol so as to compress the IP/UDP/RTP header into an ROHC header 215 having a few bytes. In addition, the PDCP layer can add an additional PDCP header 210 to the packet. The packet is delivered to the RLC layer, and the RLC layer adds an RLC header 205 including a sequence number and division/concatenation information to the RLC header 205.

The packet is delivered to a physical layer through a MAC layer, has a cyclic redundancy check (CRC) field added thereto in a physical layer, and is transmitted through a wireless channel. Herein, the CRC field is employed in order to inform a CODEC of if errors have occurred in the transmitted VoIP packet. Herein, the coverage 235 of the CRC 230 added to the packet in the physical layer corresponds to the overall packet except for the CRC field. In other words, the CRC may determine only if errors have occurred in the overall VoIP packet.

However, in the preferred operation of processing the VoIP packet, if errors have occurred in an RLC header, a PDCP header, an ROHC header, and an AMR payload specific header, the received VoIP packet is discarded. In contrast, if errors have occurred in an AMR voice data, the VoIP packet is processed and delivered to a CODEC.

However, since the VoIP packet transmitted through the wireless channel is made by mixing voice data with headers added to the VoIP packet in a wireless channel or the header compression unit, it is difficult to determine if errors have occurred in the header of the VoIP packet or in a payload. In other words, since the CRC field is added to the voice packet data in a physical layer, it is difficult to detect an exact position in which errors have occurred.

Accordingly, when errors have occurred in relation to the VoIP packet, it is necessary to determine if errors have occurred in the headers.

### DISCLOSURE OF THE INVENTION

Therefore, the present invention has been made in view of the above-mentioned problems, and it is an object of the present invention to provide an apparatus and a method for efficiently processing voice packet data in a mobile communication system providing a voice service through a packet network.

It is another object of the present invention to provide an apparatus and a method for generating by a radio link control layer a header including information representing an error occurring range for voice packet data in a mobile communication system providing a voice service through a packet network.

It is still another object of the present invention to provide an apparatus and a method for transmitting/receiving by a radio link control layer a header including information representing if errors have occurred in a header of voice packet data in a mobile communication system providing a voice service through a packet network.

To accomplish the above objects, there is provided a transmission method for efficiently processing a voice packet in a mobile communication system providing a voice service through a packet network, the transmission method including the steps of receiving by a radio link control layer a voice packet for transmission from an upper layer and generating a header including information representing a type of the received voice packet and information used for checking errors in the header of the voice packet, confirming a voice data part of the voice packet using the information representing the type and determining a coverage used for performing error detection with respect to the voice packet through the confirmed voice data part, and reconstructing a voice packet including the header and the voice data and transmitting the reconstructed voice packet to a lower layer through a wireless channel, the header including the determined error detection range.

According to another aspect of the present invention, there is provided a reception method for efficiently processing a voice packet in a mobile communication system providing a voice service through a packet network, the reception method including the steps of receiving by a radio link control layer data from a lower layer and reconstructing a voice packet by using a header including information representing a packet type of the data and information used for checking an error with respect to the header of the data, extracting the information used in order to check an error in the header from the voice packet reconstructed by using the header, confirming a voice data part of the voice packet using the information representing the packet type and determining an error detection range required for determining if an error exists in a part excluding the confirmed voice data part, and determining if an error exists in the voice packet by comparing the error detection range with the information used for checking an error.

According to still another aspect of the present invention, there is provided a transmission apparatus for a radio link control which efficiently processes a voice packet in a mobile communication system providing a voice service through a packet network, the transmission apparatus includes a buffer for receiving information representing a type of a voice packet and the voice packet from an upper layer and storing the information and the voice packet, a division/concatenation module for performing division or concatenation with respect to the voice packet stored in the buffer and previously-received another voice packet such that the voice packet and another voice packet have sizes suitable for transmission through a wireless channel, a header generating module for generating a header including information representing a sequence number used for distinguishing the voice packet and another voice packet, information representing a length of the voice packet, and information representing if errors exist in the header of the voice packet, and an error information coverage determining module for distinguishing a voice data part and a header part of the voice packet using information representing the type and determining an error occurring range of the voice packet by assigning a value used for performing error detection for the header part as information used for checking errors with respect to the voice packet.

According to still another aspect of the present invention, there is provided a reception apparatus for radio link control which efficiently processes a voice packet in a mobile communication system providing a voice service through a packet network, the reception apparatus including a buffer for receiving data from a lower layer and storing the data, a header extracting module for extracting information representing a type of the data and information representing if errors exist in a header of the data from the received data, an error detection range calculating module for determining a voice data part of the data using the information representing the type and determining an error detection range used for determining if errors exist in a part excluding the determined voice data part, and an error information comparison module for determining if errors exist in the header by comparing an error occurring range predetermined based on the type information with the information representing if errors exist in the header of the data.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a block diagram illustrating the structure of a typical mobile communication system performing VoIP;

FIG. 2 illustrates the format of a VoIP packet according to the present invention;

FIG. 3 illustrates the structure of the RLC layer performing VoIP according to the present invention;

FIG. 5 illustrates the operation of the RLC layer when at least two RLC PDUs are included in one RLC PDU according to the present invention;

FIG. 6 is a flowchart illustrating an RLC transmission operation according to the present invention;

FIG. 7 is a flowchart illustrating an RLC reception operation according to the present invention;

FIG. 8 is a block diagram illustrating the structure of an RLC transmission apparatus according to one embodiment of the present invention; and

FIG. 9 is a block diagram illustrating the structure of an RLC reception apparatus according to the present invention.

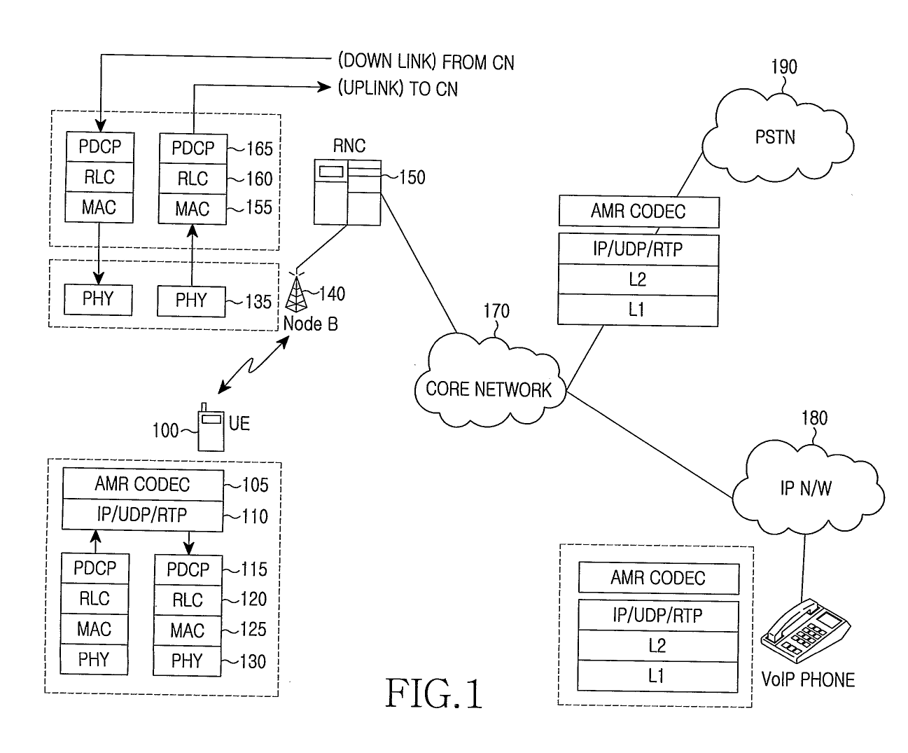

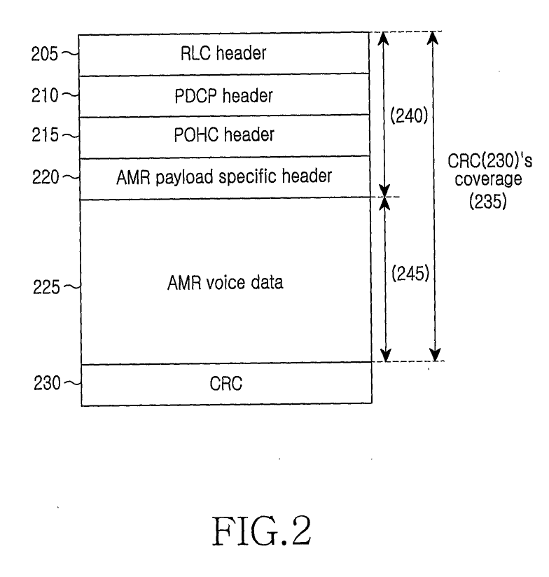

### BEST MODE FOR CARRYING OUT THE INVENTION

Hereinafter, a preferred embodiment of the present invention will be described in detail with reference to the accompanying drawings. Note that the same or similar components in drawings are designated by the same reference numerals as far as possible although they are shown in different drawings. In the following description of the present invention, a detailed description of known functions and configurations incorporated herein will be omitted when it may make the subject matter of the present invention rather unclear. In addition, terminologies to be described later will be defined on the basis of the overall description of the present invention.

The present invention proposes a method for determining if an error of a voice header has occurred in a mobile communication system providing a voice service through a packet network. In other words, the present invention proposes a method for efficiently processing the received packet by determining if an error has occurred in the header of a VoIP packet in the processing of the VoIP packet. In addition, the present invention proposes a method in which a CODEC processing the VoIP packet more efficiently performs error concealment. According to one embodiment of the present invention, there is suggested a method for adding by an RLC layer a CRC field used for determining if errors have occurred in a header of the voice packet.

Hereinafter, this overall operation according to the present invention will be described.

1. Transmission Side

An upper layer in the transmission side delivers an RLC SDU to an RLC layer. Herein, the RLC SDU carries information regarding the coverage of the CRC-header. Accordingly, the RLC layer in the transmission side determines the coverage of the CRC-header, performs a predetermined CRC operation with respect to the coverage of the CRC-header, and attaches the result of the CRC operation to the RLC header. Herein, the RLC header includes the information regarding the coverage of the CRC-header.

2. Reception Side

An RLC layer in the reception layer having received an RLC PDU performs a CRC operation with respect to the CRC coverage. Herein, the CRC coverage is determined on the basis of information included in the RLC PDU header.

Herein, if the RLC layer successfully performs the CRC operation, the RLC layer delivers the RLC SDU to the upper layer. If the RLC layer fails to perform the CRC operation, the RLC layer discards the RLC SDU.

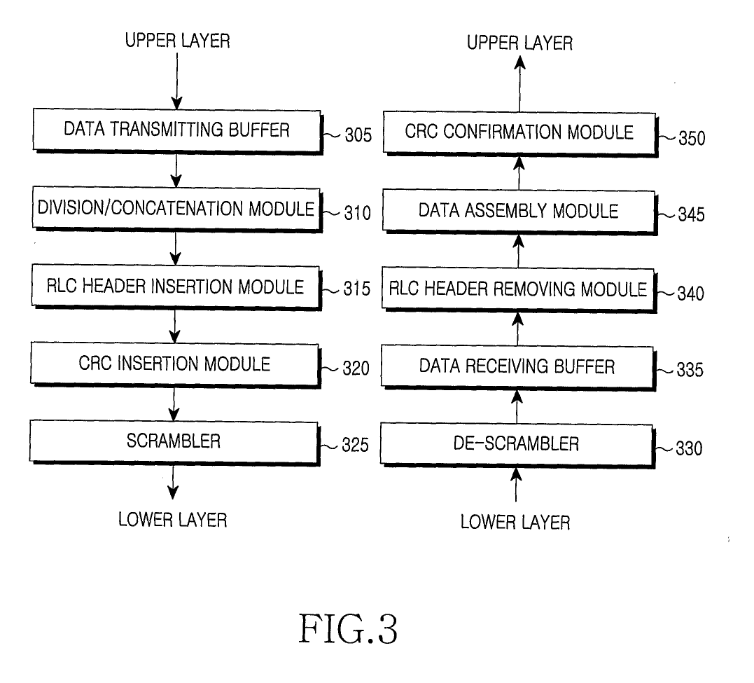

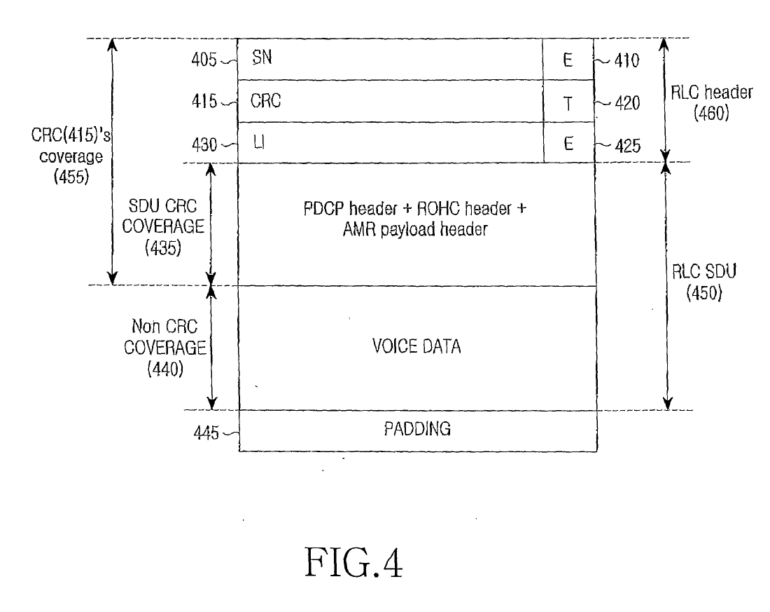

FIG. 3 illustrates the structure of the RLC layer according to one embodiment of the present invention.

An RLC layer in the transmission side includes a data transmission buffer 305, a division/concatenation module 310, an RLC header insertion module 315, a CRC insertion module 320, and a scrambler 325. From among these components, the data transmission buffer 305, the division/concatenation module 310, the RLC header insertion module 315, and the scrambler 325 have the conventional structures. The CRC insertion module 320 is newly included in the structure of the RLC layer according to the present invention.

In contrast, an RLC layer in the reception side includes a de-scrambler 330, a data reception buffer 335, an RLC header extracting module 340, a data assembly module 345, and a CRC confirmation module 350. From among these components, the de-scrambler 330, the data reception buffer 335, the RLC header extracting module 340, the data assembly module 345 have the conventional structures. According to the present invention, the CRC confirmation module 350 is newly included in the RLC layer in the reception side.

Hereinafter, description about the RLC layer in the transmission side will be given.

If an RLC SDU reaches the RLC layer from the upper layer, the RLC SDU is stored in the data transmission buffer 305. Herein, the upper layer delivers type information (regarding the CRC coverage for the RLC SDU) with the RLC SDU. The type information is used when the CRC insertion module 320 performs a CRC operation.

Prior to the transmission of the RLC SDU, the division/concatenation module 310 divides or concatenates the RLC SDU into packets having sizes suitable for transmission. A portion of the divided RLC SDUs or the concatenated RLC SDUs is included in an RLC PDU payload. The RLC header insertion module 315 inserts the header into the RLC PDU payload. The RLC header includes a sequence number and a length indicator (LI). The sequence number corresponds to an integer (within the range of 0 to 127) which monotonously increases for every RLC PDU. The LI implying information regarding division/concatenation for an RLC SDU represents the position of the last byte of an RLC SDU in the RLC PDU.

The CRC insertion module 320 confirms the CRC coverage based on the type information and performs a predetermined CRC operation with respect to the CRC coverage. Then, the CRC insertion module 320 inserts the resulting value of the CRC operation into the header of the RLC PDU.

The scrambler 325 decodes the RLC PDU such that another user cannot have access to the RLC PDU. The RLC PDU having undergone the processes described above is delivered to the lower layer. The lower layer deals with the delivered RLC PDU through predetermined processes and then transmits the RLC PDU through a wireless channel.

Hereinafter, description about the RLC layer in the reception side will be described.

The de-scrambler 330 de-scrambles an RLC PDU delivered from the lower layer so as to make an ordinary RLC PDU. The data reception buffer 335 receives and stores ordinary divided RLC PDUs processed through the de-scrambler 330 until a perfect RLC PDU is formed. For example, on the assumption that the transmission side divides a predetermined RLC SDU into two RLC PDUs and transmits the divided RLC PDUs, the data reception buffer 335 stores the divided RLC PDUs until all of the two RLC PDUs reaches.

The RLC header extracting module 340 separates the headers of the RLC PDUs from the payloads of the RLC PDUs. The data assembly module 345 reconstructs an RLC SDU from the payloads. Herein, the data assembly module 345 reconstructs the RLC SDU using sequence numbers and LIs included in RLC PDU headers.

The CRC confirmation module 350 performs a CRC operation with respect to the reconstructed RLC SDU so as to determine if errors have occurred in the header of the RLC SDU. If errors have occurred in the header of the RLC SDU, the CRC confirmation module 350 discards the erroneous RLC SDU. Otherwise, the CRC confirmation module 350 delivers the error-free SDU to the upper layer.

Referring to FIG. 4, an RLC PDU includes an RLC header and an RLC payload.

The RLC header includes an SN field 405, E fields 410 and 425, a CRC field 415, T fields 420, and an LI field 430. Herein, the CRC field and the T field in the header field are newly suggested in the present invention.

The RLC payload includes an RLC SDU 450 and a padding field 445. In relation to this, the structure shown in FIG. 4 is employed when one RLC SDU is received in one RLC PDU without division or concatenation.

For reference, in VoIP communication, voice data are generated with a predetermined time interval of 20 msec and included in one RLC SDU. Therefore, RLC SDUs are mostly transmitted without undergoing division or concatenation.

Hereinafter, description about the fields newly introduced according to the present invention will be briefly given.

The CRC field 415 has the resulting value of a predetermined CRC operation for the overall CRC coverage 455 of the headers in the RLC PDU. If errors have occurred in the overall CRC coverage, a concerned RLC SDU must be discarded. For example, in a predetermined VoIP packet, the overall CRC coverage includes a PDCP header, an ROHC header, an AMR payload header, and an RLC header (excluding the CRC field).

The T field 420 represents the type of voice data. According to the present invention, types of voice data are set as two types of ‘voice frame’ and ‘silent descriptor (SID)’. The type information directly relates to the size of the voice data. In detail, when the type indicates the SID, the voice data has the size of 39 bits. When the type indicates the voice frame, the voice data have a predetermined size according to the operation of an AMR CODEC.

For example, if the AMR CODEC operates at a data rate of 12.2 kbps, the voice data have the size of 244 bits. The relationship between the operation mode of the AMR CODEC and the size of voice data is shown in Table 1.

TABLE 1

| Frame Type | AMR mode | Voice data (bits) |
|---|---|---|
| 0 | AMR 4.75 kbit/s | 95 |
| 1 | AMR 5.15 kbit/s | 103 |
| 2 | AMR 5.90 kbit/s | 118 |
| 3 | AMR 6.70 kbit/s | 134 |
| 4 | AMR 7.40 kbit/s | 148 |
| 5 | AMR 7.95 kbit/s | 159 |
| 6 | AMR 10.2 kbit/s | 204 |
| 7 | AMR 12.2 kbit/s | 244 |
| 8 | AMR SID | 39 |

As described above, the AMR CODEC makes voice data and then attaches an AMR payload specific header to the voice data. The AMR payload specific header has a frame type field, and the frame type field has information representing an AMR operation mode. The frame type, the AMR mode, and the size of payload have the relationship suggested through Table 1.

Accordingly, the PDCP layer receives a VoIP packet (in which an IP/UDP/RTP header is added to the voice data and the AMR payload specific header) and then compresses the IP/UDP/RTP header. Herein, the PDCP layer determines the type of the VoIP packet based on the value in the frame type field of the AMR payload specific header.

In detail, if the value in the frame type field is within the range of 0 to 7, the type of the VoIP packet is the voice frame. In addition, if the value in the frame type field is 8, the type of the VoIP packet is the SID.

The PDCP layer delivers the VoIP packet having the compressed header and the type value to the RLC layer. The RLC layer inserts the type value into the T field of the RLC PDU so as to inform the reception side of the type of the voice data.

As described above, in the VoIP communication, since the user terminal and the RNC always recognize the AMR operation mode through the AMR payload specific header, the size of voice data of an RLC SDU in a predetermined AMR mode is determined according to the type.

In other words, since the type of the voice data is inserted into the AMR payload specific header as a frame type, the frame type is analyzed prior to the compression of the header of the VoIP packet received from the PDCP layer. If the value of the frame type is within the range of 0 to 7, the T is set to the ‘voice frame’ to be transmitted to the RLC layer. If the value of the frame type is 8, the T is set to the ‘SID’ to be transmitted to the RLC layer.

Hereinafter, a procedure of performing by the RLC layer a CRC operation with respect to the RLC SDU received from the upper layer will be described. Herein, the AMR mode is not arbitrarily changed, and it is assumed that the RLC layer recognizes a current AMR mode.

The RLC layer receives an RLC SDU from the upper layer at a predetermined time point. Herein, it is assumed that the RLC SDU is included in one RLC PDU and is not concatenated with another SDU.

The RLC layer confirms a Non CRC coverage based on type information. If the type information indicates the ‘voice frame’, the Non CRC coverage corresponds to the range of the last bit of the RLC SDU to an x^{th} bit of the RLC SDU. In a predetermined AMR mode, the x represents the size of voice data shown in Table 1. In detail, if the AMR mode has a data rate of 12.2 kbps, the x corresponds to 244 bits. If the type information indicates the ‘SID’, the Non CRC coverage corresponds to the range of the last bit of the RLC SDU to 39^{th} bit of the RLC SDU. Accordingly, the RLC layer can confirm the SDU CRC coverage with respect to the RLC SDU. The SDU CRC coverage corresponds to a part excluding the Non CRC coverage.

The RLC layer creates an RLC PDU header to be added to the RLC SDU. The RLC PDU header includes SN, E and T, and LI and E. The LI is inserted depending on if there is PDU padding and if the RLC SDU is concatenated with another SDU.

The RLC layer confirms the overall CRC coverage through Equation 1.
Overall CRC coverage=RLC header excluding CRC field+SDU CRC coverage. Equation 1

The RLC layer performs a CRC operation with the overall CRC coverage and then inserts the resulting value of the CRC operation into the CRC field 415.

The RLC PDU shown in FIG. 4 is formed after the process is completed. The RLC PDU is transmitted to the reception side through a wireless channel.

Hereinafter, the operation after the reception of the RLC PDU in the reception side will be described.

The RLC layer having received an RLC PDU extracts an RLC header and an RLC SDU from the RLC PDU.

In addition, the RLC layer confirms the Non CRC coverage for the RLC SDU through a T field of the RLC header. If the T field indicates a voice frame, the Non CRC coverage corresponds to the range of the last part of the RLC SDU to a part corresponding to the size of voice data in a corresponding AMR mode. If the T field indicates the SID, the Non CRC coverage corresponds to the range of the last bit of the RLC SDU to the 39^{th} bit.

Then, the RLC layer confirms the SDU CRC coverage for the RLC SDU. The SDU CRC coverage corresponds to an SDU area excluding the Non CRC coverage.

Accordingly, the RLC layer confirms the overall CRC coverage through Equation 2.
Overall CRC coverage=RLC header excluding CRC field+SDU CRC coverage Equation 2

The RLC layer performs a predetermined CRC operation with respect to the overall CRC coverage and then compares the resulting value of the CRC operation with the value of the CRC field. If the two values are identical to each other, the RLC layer regards the SDU as an error-free SDU and transmits the SDU to the upper layer. In contrast, if the two values are not identical to each other, the RLC layer regards the SDU as an erroneous SDU and discards the SDU.

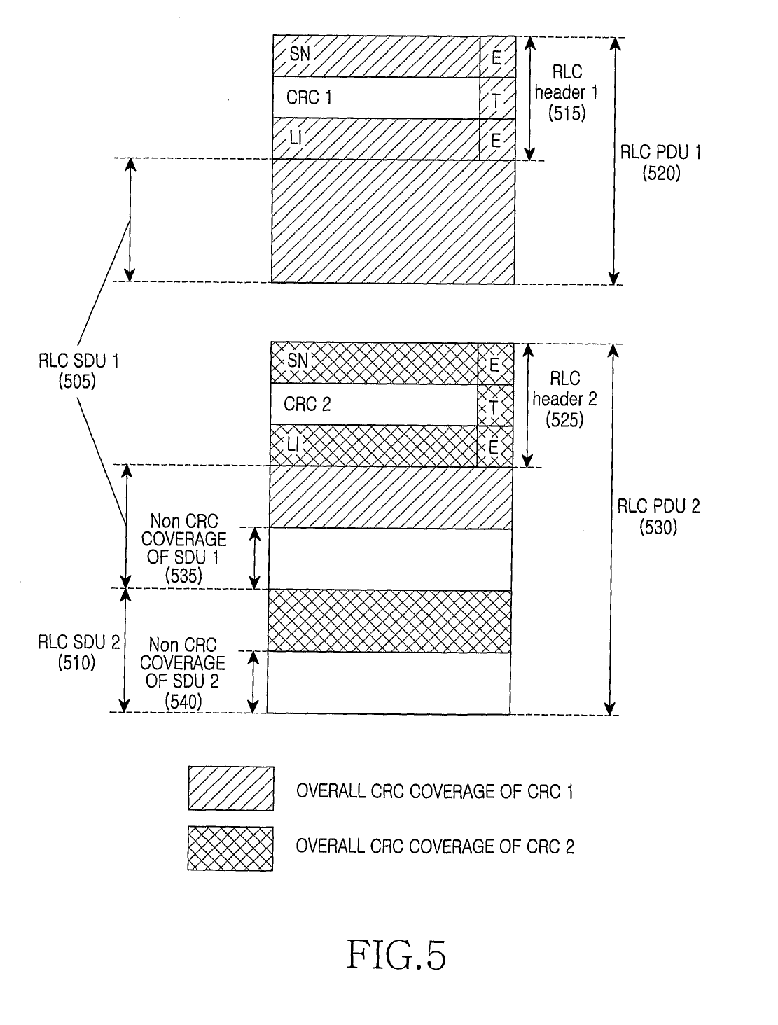

FIG. 5 illustrates the operation of the RLC layer when at least two RLC PDUs are included in one RLC PDU according to the present invention.

As described with reference to FIG. 4, the overall CRC coverage corresponds to the header of an RLC PDU and the RLC SDU excluding voice data. In other words, when the RLC SDU and the RLC PDU have an one-to-one relationship, the overall CRC coverage is clearly determined. However, when the RLC SDU and the RLC PDU do not have an one-to-one relationship, it is necessary to make a rule of determining the overall CRC coverage.

For example, when an RLC SDU is divided into several RLC PDUs to be transmitted, there may be several RLC PDU headers corresponding to the RLC SDU. In other words, several RLC PDU headers may exist in order to form the overall CRC coverage. Cases in which an RLC SDU and an RLC PDU do not have one-to-one relationship as described above are as follows:

1. A case in which at least two perfect RLC SDUs are included in an RLC PDU;

2. A case in which at least two RLC SDUs are included in an RLC PDU and the first divided segment of the first RLC SDU is transmitted through a previous RLC PDU;

3. A case in which at least two RLC SDUs are included in an RLC PDU, and a first RLC SDU is a perfect RLC SDU; and

4. A case in which only one RLC SDU is included in an RLC PDU, and the first divided segment of the RLC SDU is transmitted in a previous RLC PDU.

Herein, only the second case from among the cases is valid in VoIP communication. In the first case, RLC SDUs having very small sizes may be included in one RLC PDU. In the VoIP communication, one SDU is generated with a predetermined time interval of 20 msec and the SDU must be transmitted as soon as the SDU is generated. That is, in the first case and the third case, although the first RLC SDU reaches the RLC layer, the RLC SDU is not instantaneously transmitted, but transmitted together with an SDU newly generated after the predetermined time interval of 20 msec.

Accordingly, it is not preferred that voice data sensitive to delay are stored in the RLC buffer and then transmitted. Therefore, it is regarded that the first case and the third case do not occur.

In the fourth case where an RLC SDU having the very large size is divided into several RLC PDUs to be transmitted, remaining parts of the SDU are included in the RLC PDUs except for the first segment of the RLC SDU and the last segment of the RLC SDU. However, in the VoIP communication, the size of the SDU is restricted. Accordingly, an SDU having the large size to be transmitted through several PDUs is not generated. Accordingly, the fourth case is also not considered.

In contrast, the second case denotes a case in which an SDU having the size unable to be transmitted at one time is generated and divided into two parts thereof, and the second segment of the SDU is concatenated with another SDU and transmitted. This case may occur in VoIP communication. This is because the size of a packet may be changed when the header of the packet is compressed.

Accordingly, referring to FIG. 5, a method of calculating the CRC coverage when the SDU is divided and transmitted and when the second segment of the SDU is inserted into a next PDU together with another SDU will be described below.

An RLC layer receives an RLC SDU 1 505 from the upper layer at a predetermined time point of t. At this time, the RLC layer confirms a Non CRC coverage 535 based on type information delivered together with the RLC SDU from the upper layer. The RLC layer determines the SDU CRC coverage based on the Non CRC coverage 535. The RLC layer divides the first RLC SDU into two parts because the size of the first RLC SDU exceeds the size of the RLC PDU. Then, the RLC layer determines header information regarding the RLC PDU including the first segment of the SDU (SN, ‘E and T’, and ‘LI and E’). If the header information is determined, the RLC layer determines the overall CRC coverage for the first RLC SDU, performs the CRC operation with respect to the overall CRC coverage, and then inserts the resulting value of the CRC operation into a CRC field of the first RLC PDU 520.

The first RLC PDU 520 is formed after the above-described process. The first RLC PDU 520 is transmitted to the reception side through a wireless channel.

In contrast, the operation of the reception side after the reception of the RLC PDU will be described below.

If an RLC layer in the reception layer receives the RLC PDU, the RLC layer determines if a perfect RLC SDU is reconstructed based on the RLC PDU. If the perfect RLC SDU is not reconstructed, the RLC layer stores the RLC PDU in a data reception buffer.

For example, the second RLC SDU 510 is delivered to an RLC layer in the transmission side from the upper layer after a predetermined time interval (20 msec) elapses from a predetermined time point of t.

Herein, the RLC layer determines a Non CRC coverage 540 of the second RLC SDU and confirms an SDU CRC coverage of the second RLC SDU based on the Non CRC coverage 540.

The RLC layer determines the header information of the second RLC PDU when the second RLC SDU is received and determines an overall CRC coverage for the second RLC SDU by adding an SDU CRC coverage for the second RLC SDU to the header information. The RLC layer performs a CRC operation with respect to the overall CRC coverage and then inserts the resulting value of the CRC operation into a CRC field of the second RLC PDU.

The second RLC PDU 530 is formed after the process and transmitted to the reception side through a wireless channel.

If the reception side receives the second RLC PDU, the first RLC SDU and the second RLC SDU are reconstructed using the first RLC PDU stored in the reception buffer.

The overall CRC coverage for the first RLC SDU is determined through Equation 3.
Overall CRC coverage(SDU 1)=RLC header(SDU 1_{first segment})+SDU CRC coverage(SDU 1) Equation 3

Herein, the RLC header (SDU 1_{first segment}) denotes header information of an RLC PDU including the first segment of the first RLC SDU. In addition, the SDU CRC coverage (SDU 1) denotes the SDU CRC coverage for the first SDU and is determined by the value of the T of the RLC header (SDU 1_{first segment}).

The RLC layer performs a predetermined CRC operation with respect to the overall CRC coverage (SDU 1). Then, the RLC layer compares the resulting value of the CRC operation with a CRC value of the RLC header (SDU 1_{first segment}) so as to determine if errors have occurred. If errors have occurred, the RLC layer discards the first RLC SDU. If errors do not occur, the RLC layer transmits the first RLC SDU to the upper layer.

The reception side performs the same process with respect to the second RLC SDU. In other words, the reception side determines if errors have occurred in the overall CRC coverage for the second RLC SDU and then determines if it is necessary to discard the second RLC SDU.

Accordingly, a method for determining an overall CRC coverage with respect to the x^{th} SDU is shown in Equation 4.
Overall CRC coverage(SDU x)=RLC header(SDU x_{first segment})+SDU CRC coverage(SDU x) Equation 4

If the RLC transmission side receives a predetermined x^{th} SDU (SDU x) from the upper layer, the RLC transmission side calculates the SDU CRC coverage for the x^{th} SDU and confirms the RLC header of the RLC PDU (excluding a CRC field) having a starting point of the x^{th} SDU from among RLC PDUs including the x^{th} SDU. Then, the RLC transmission side determines the summation of the RLC header (excluding the CRC field) and the SDU CRC coverage as the overall CRC coverage.

Similarly, if the RLC reception side receives RLC PDUs from the lower layer and reconstructs the RLC SDU, the RLC reception side regards the summation of the RLC header (excluding a CRC field) of an RLC PDU having the starting point of an SDU and the SDU CRC coverage as the overall CRC coverage.

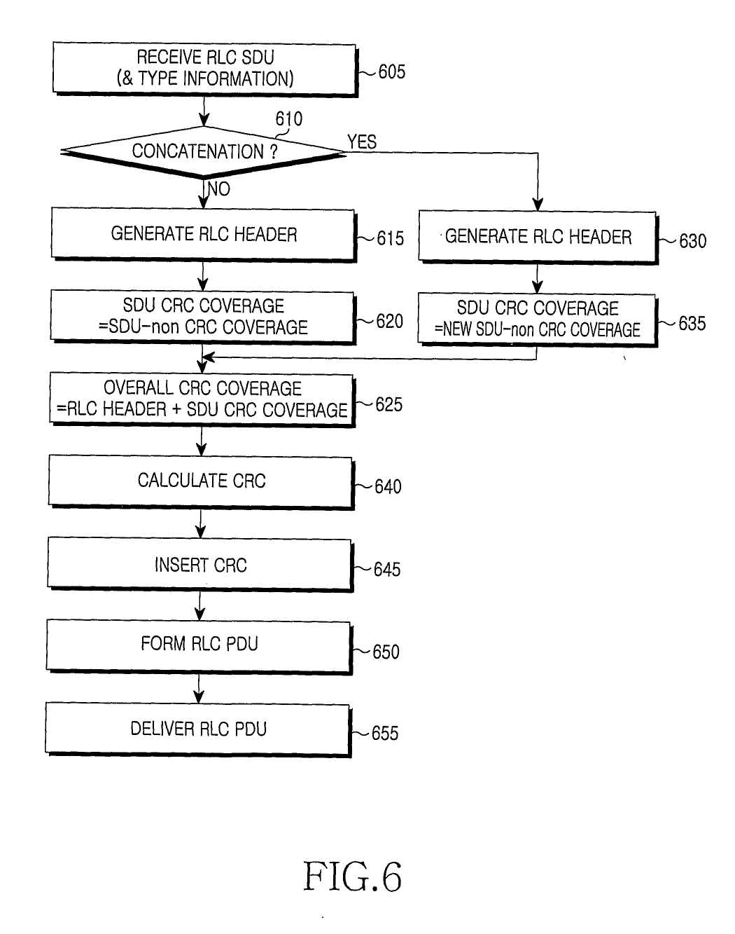

FIG. 6 is a flowchart illustrating an RLC transmission operation according to one embodiment of the present invention.

In step 605, an RLC layer in a transmission side (RLC transmission side) receives an RLC SDU from the upper layer. At this time, type information of the SDU is delivered with the RLC SDU. Herein, the type information represents if the SDU includes voice data or SID (silent descriptor).

In step 610, the RLC transmission side determines if it is necessary to concatenate the SDU with another SDU (which is not previously transmitted). In other words, the RLC transmission side determines if other SDUs are previously stored in the data transmission buffer before the reception of the SDU from the upper layer. If other SDUs exist in the data transmission buffer at a time point to receive the SDU from the upper layer, step 630 is performed. If the data transmission buffer is empty at a time point to receive the SDU from the upper layer, step 615 is performed.

If step 615 is performed, the RLC SDU may be formed as one RLC PDU or may be divided into several RLC PDUs. The same transmission operation is applied to the two cases.

In step 615, the RLC transmission side makes an RLC header to be inserted into an RLC PDU. Herein, the RLC header includes type information and a sequence number. The type information representing the type of the payload of the RLC PDU is set to the same type as received in step 605.

In step 620, the RLC transmission side calculates the SDU CRC coverage. Herein, the SDU CRC coverage corresponds to the part obtained by excluding the Non CRC coverage from the range of the end part of the RLC SDU received in step 605. The Non CRC coverage referring to a value determined according to the SDU type represents a range of a part occupied by VoIP voice data of a predetermined SDU starting from the end of the SDU.

In step 625, the RLC transmission side calculates the overall CRC coverage. Herein, the overall CRC coverage corresponds to a part obtained by adding the RLC header created in step 615 to the SDU CRC coverage.

In step 640, the RLC transmission side performs a predetermined CRC operation with respect to the overall CRC coverage.

In step 645, the RLC transmission side inserts the resulting value of the CRC operation into an RLC header.

In step 650, the RLC transmission side forms the RLC PDU. The RLC PDU is formed through the combination of the RLC header and the RLC payload. The RLC payload may include one perfect RLC SDU or only a portion of the RLC SDU. If the RLC payload includes only a portion of the RLC SDU, remaining parts of the RLC SDU are stored in a data transmission buffer. The remaining parts of the RLC SDU are concatenated with other RLC SDUs to be transmitted later.

In step 655, the RLC transmission side delivers the RLC PDU to the lower layer. The RLC PDU is suitably processed in the lower layer and then delivered to an RLC layer in a reception side (RLC reception side) through a wireless channel.

In the meantime, if another SDU (old SDU) exists in the data transmission buffer at a time point to receive an SDU in step 605, the RLC transmission side performs step 630 after step 610. The execution of step 630 refers to that the RLC PDU to be formed in step 650 has the old SDU concatenated with the RLC SDU received in step 605.

In step 630, the RLC transmission side makes an RLC header. At this time, a sequence number and a type value are set to the same value as set in step 615. Herein, since two SDUs are concatenated with each other and transmitted, the concatenation information of the SDUs is expressed using an LI.

In step 635, the RLC transmission side calculates the SDU CRC coverage. Although the RLC transmission side has two RLC SDUs, the SDU CRC coverage corresponds to a new SDU received in step 605.

Accordingly, the SDU CRC coverage corresponds to a part obtained by excluding the Non CRC coverage from the range of the end part of the RLC SDU received in step 605. The Non CRC coverage referring to a value determined according to the SDU type represents a range of a part occupied by VoIP voice data of a predetermined SDU based on the end part of the SDU. The RLC transmission side performs step 625 after step 635.

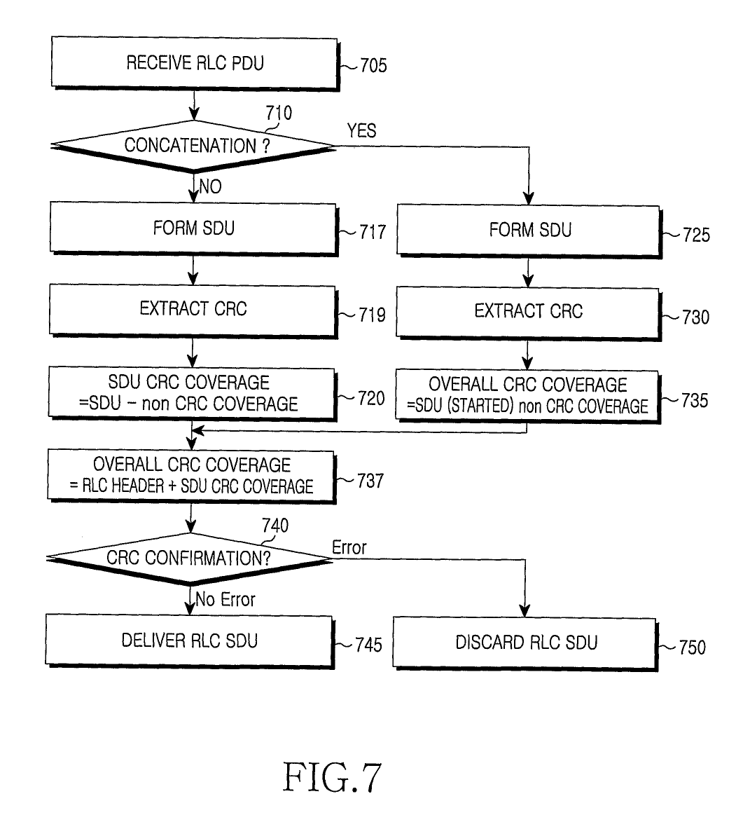

FIG. 7 is a flowchart illustrating the operation of the RLC reception side according to the present invention.

In step 705, the RLC reception side receives an RLC PDU from the lower layer. In step 710, the RLC reception side determines if two SDUs are concatenated with each other in the received RLC PDU. If two SDUs are concatenated with each other, step 725 is performed. If only one SDU is included in the received RLC PDU, step 717 is performed.

In step 717, the RLC reception side reconstructs the RLC SDUs using the received RLC PDU. This step denotes a step in which a part corresponding to an RLC SDU is extracted from the RLC PDU payload using the header information of the received RLC PDU. In the meantime, the meaning that the RLC SDUs are not reconstructed using the RLC PDU received in step 705 refers to that one RLC SDU is divided into several RLC PDUs and transmitted. In this case, the RLC reception side performs the following operation. In other words, when an RLC SDU are not reconstructed using the received RLC PDU, the RLC reception side performs the following operation.

1. The RLC header information included in the received RLC PDU is stored.

2. The RLC reception side waits until another RLC PDU reaches and the RLC SDU are reconstructed.

3. If the RLC SDU is reconstructed, the RLC reception side performs step 719 and extracts a part corresponding to the RLC SDU from the received RLC PDU payload using header information of the received RLC PDU.

In step 719, the RLC reception side extracts a CRC field from a RLC header. In step 720, the RLC reception side calculates the SDU CRC coverage and performs step 737. The SDU CRC coverage corresponds to the part obtained by excluding the Non CRC coverage from the end part of the RLC SDU reconstructed in step 717. The Non CRC coverage is determined using the T value of the RLC header.

In step 737, the RLC reception side calculates the overall CRC coverage. The overall CRC coverage corresponds to a part obtained through the summation of the SDU CRC coverage and an RLC header excluding a CRC field.

In step 740, the RLC reception side performs a predetermined CRC operation with respect to the overall CRC coverage and compares the resulting value with the CRC extracted in step 719. At this time, if the two CRCs are identical to each other, this refers to that errors do not exist in the overall CRC coverage. Therefore, the RLC reception side delivers the RLC SDU to the upper layer in step 745 and terminates the reception operation.

In contrast, if the two CRC values are not identical to each other, this refers to that errors exist in the overall CRC coverage. Therefore, the RLC reception side discards the RLC SDU in step 750 and then terminates the reception operation.

In addition, if the reception side receives an RLC PDU having two RLC SDUs concatenated with each other in step 705, the RLC reception side performs step 725 after step 710. In step 725, the RLC reception side reconstructs the RLC SDUs using the received RLC PDU.

In step 730, the RLC reception side extracts a CRC field from the received RLC PDU.

In step 735, the RLC reception side calculates the SDU CRC coverage from the RLC SDU reconstructed in step 725. Herein, an SDU used for calculating the SDU CRC coverage corresponds to the first RLC SDU included in the RLC PDU. Hereinafter, detailed description about this will be given.

The execution of step 725 means that the RLC PDU received in step 705 has one of the following structures.

1. A case in which the last part of a certain divided and transmitted RLC SDU is concatenated with a new RLC SDU in one RLC PDU, and the new RLC SDU is perfectly included in the RLC PDU.

2. A case in which the last part of a certain divided and transmitted RLC SDU is concatenated with a new RLC SDU in one RLC PDU and the new RLC SDU is not perfectly included in the RLC PDU.

Accordingly, CRC of the RLC PDU received in step 705 is employed for a newly commencing RLC SDU of the RLC PDU because CRC for the divided and transmitted RLC SDU is performed in the previous PDU in the two cases. Therefore, an RLC SDU coverage is found with respect to the newly commencing RLC SDU. However, in the second case, since an RLC SDU to be processed through a CRC operation has no perfect structure, the CRC operation is suspended.

In step 735, if the calculation of an SDU CRC coverage is completed, step 737 is performed. Hereinafter, description about steps 737 to 750 will be omitted.

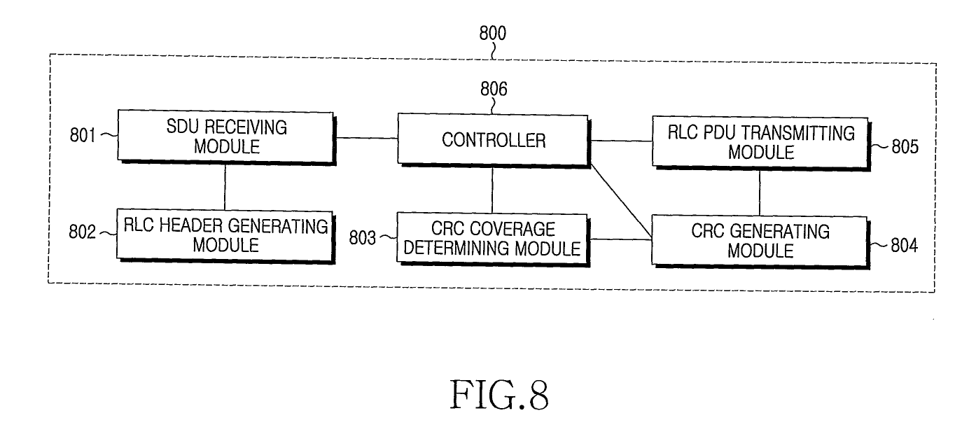

FIG. 8 is a block diagram illustrating the structure of an RLC transmission apparatus 800 according to one embodiment of the present invention.

The RLC transmission apparatus 800 includes an SDU receiving module 801, an RLC header generating module 802, a CRC coverage determining module 803, a CRC calculating module 804, an RLC PDU transmitting module 805, and a controller 806.

The SDU receiving module 801 receives an RLC SDU including SDU type information from the upper layer. The type information represents if the SDU includes voice data or an SID.

The controller 806 determines if another SDU is stored in a data transmission buffer before obtaining the SDU received by the SDU receiving module 801. If another SDU exists in the data transmission buffer at a time point to receive the SDU from the upper layer, the controller 806 orders the RLC header generating module 802 to concatenate the SDU with another SDU and generate a header.

The RLC header generating module 802 generates an RLC header according to the concatenation order of the controller 806. At this time, if there is no concatenation order from the controller 806, the RLC header generating module 802 makes an RLC header to be inserted into an RLC PDU regardless of a case where the RLC SDU is reconstructed into one RLC PDU or a case where the RLC SDU is divided into several RLC PDUs. The RLC header includes type information and a sequence number. The type information indicates the type of the RLC PDU payload and has a value identical to the type value received in step 605.

If the RLC header generating module 802 receives the concatenation order from the controller 806, the RLC header generating module 802 makes an RLC header including an LI representing concatenation information. Herein, a sequence number and a type value of the RLC header have values identical to those used when concatenation is not performed.

The CRC coverage determining module 803 receives information regarding a concatenation state of the received SDU from the controller 806 and calculates a CRC coverage. First, if the received SDU is not concatenated, the SDU CRC coverage corresponds to the part obtained by excluding the RLC header of the SDU and a Non CRC coverage (i.e., a CRC field) from the end of the received RLC SDU.

If the received SDU is concatenated, the SDU coverage corresponds to a part excluding a Non CRC coverage (i.e., a CRC field of a new SDU) and the RLC header of the new SDU from the new SDU.

The CRC calculating module 804 performs a predetermined CRC operation with respect to a part obtained through the summation of the RLC header (formed by the RLC header generating module 802) and the calculated CRC coverage and then transmits the CRC operation result to the RLC PDU transmitting module 805.

The RLC PDU transmitting module 805 inserts the received CRC operation result into the RLC header and forms the RLC PDU by coupling the RLC header with an RLC payload. The RLC payload may have one perfect RLC SDU or a portion of the RLC SDU. If the RLC payload has a portion of the RLC SDU, remaining parts of the RLC SDU are stored in the data transmission buffer. The remaining parts of the RLC SDU will be concatenated with another RLC SDU and then transmitted later. The RLC PDU transmitting module 805 delivers the RLC PDU to the lower layer. The lower layer suitably processes the RLC PDU and then delivers the RLC PDU to the reception side through a wireless channel.

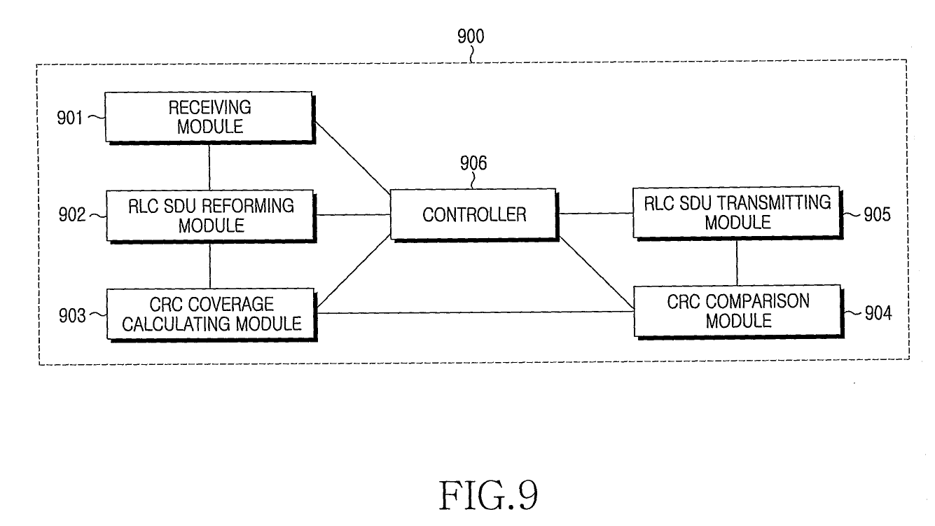

FIG. 9 is a block diagram illustrating the structure of an RLC reception apparatus 900 according to one embodiment of the present invention.

The RLC reception apparatus 900 includes an RLC PDU receiving module 901, an RLC SDU reconstructing module 902, a CRC coverage calculating module 903, a CRC comparison module 904, an RLC SDU transmitting module 905, and a controller 906.

The RLC PDU receiving module 901 receives an RLC PDU from the lower layer.

The controller 906 determines if two SDUs are concatenated with each other in the received RLC PDU and controls the RLC SDU reconstructing module 902 according to the concatenation state of the RLC PDU. In addition, the controller 906 determines if one RLC SDU is reconstructed using the received RLC PDU and controls the RLC SDU reconstructing module 902 according to the determination result.

If the received RLC SDUs are not concatenated with each other and if the RLC SDU reconstructing module 902 can reconstruct the RLC SDUs of the RLC PDU according to the order of the controller 906, the RLC SDU reconstructing module 902 extracts a part corresponding to the RLC SDU from the payload of the RLC PDU using the header information of the received RLC PDU and then transmits the part to the CRC coverage calculating module 903. If the RLC SDU reconstructing module 902 cannot reconstruct the received SDU (if one RLC SDU is divided into several RLC PDUs and transmitted), the RLC SDU reconstructing module 902 stores RLC header information of the received RLC PDU and waits until a next RLC PDU reaches and the RLC SDU is reconstructed. Thereafter, if the RLC SDU is reconstructed, a part corresponding to the RLC SDU is extracted from the RLC PDU payload based on header information of the received RLC PDU and then transmitted to the CRC coverage calculating module 903.

When the RLC SDU reconstructing module 902 receives the reconstructed concatenated RLC SDUs of the RLC PDU, the RLC SDU reconstructing module 902 reconstructs RLC SDUs based on the received RLC PDU according to the order of the controller 906.

The received RLC PDU has a structure in which the last part of the divided and transmitted RLC SDU is concatenated with a new RLC SDU in one RLC PDU, and the new RLC SDU is perfectly included in the RLC PDU or a structure in which the last part of the divided and transmitted RLC SDU is concatenated with a new RLC SDU in one RLC PDU, and the new RLC SDU is not perfectly included in the RLC PDU. Since the CRC coverage calculating module 903 performs a CRC operation for the divided and transmitted RLC SDUs based on the previous PDU, the CRC coverage calculating module 903 performs a CRC operation of the received RLC PDU by calculating an RLC SDU CRC coverage for an RLC SDU newly commencing in the received RLC PDU. However, in the second structure, since an RLC SDU processed through a CRC operation is not perfectly reconstructed, the CRC operation is suspended until the RLC SDU is perfectly reconstructed.

The CRC coverage calculating module 903 extracts a CRC value from the RLC header of the received RLC PDU and then transmits the CRC value to the CRC comparison module 904. In addition, the CRC coverage calculating module 903 calculates the SDU CRC coverage. The SDU CRC coverage indicates the part obtained by excluding a Non CRC coverage based on the end of the reconstructed SDU. The Non CRC coverage is determined based on the T value of the RLC header. Thereafter, the CRC coverage calculating module 903 calculates the overall CRC coverage and transmits the overall CRC coverage to the CRC comparison module 904. The overall CRC coverage corresponds to a part obtained through the summation the RLC header excluding the CRC field of the RLC PDU and the SDU CRC coverage.

The CRC comparison module 904 performs a predetermined CRC operation with respect to the received overall CRC coverage and then compares the resulting value of the CRC operation with the extracted CRC value.

If two CRC values are identical to each other as the comparison result, it means that errors are not found in the overall CRC coverage. Therefore, the controller 906 orders the RLC SDU transmitting module 905 to deliver the RLC SDU to the upper layer. If the two CRC values are not identical to each other as the comparison result, it means that errors exist in the overall CRC coverage. Therefore, the controller 906 discards the RLC SDU and then terminates its operation.

### INDUSTRIAL APPLICABILITY

Hereinafter, an effect by one representative embodiment of the invention disclosed herein will be briefly described.

According to the present invention, it is possible for a transmission/reception RLC layer to quickly determine if errors have occurred in a voice packet header by using information representing a type of a voice packet to be transmitted and information including an error detection result of the voice packet in a mobile communication system providing a voice service using a packet network. In other words, it is possible to efficiently process a voice packet sensitive to time delay by quickly determining if errors have occurred in a voice packet header.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A transmission method for efficiently processing a voice packet in a mobile communication system providing a voice service through a packet network, the transmission method comprising the steps of:
receiving by a radio link control layer a voice packet for transmission from an upper layer and generating a header including information representing a type of the received voice packet and information used for checking errors in the header of the voice packet;
confirming a voice data part of the voice packet using the information representing the type and determining a coverage used for performing error detection with respect to the voice packet through the confirmed voice data part; and
reconstructing a voice packet including the header and the voice data and transmitting the reconstructed voice packet to a lower layer through a wireless channel, the header including the determined error detection range.

2. The transmission method as claimed in claim 1, wherein the radio link control layer receives from the upper layer information representing if the voice packet is voice data or silent descriptor data and assigns the information to a type field of the generated header.

3. The transmission method as claimed in claim 1, wherein the radio link control layer receives the voice packet for transmission from the upper layer and generates the header by further inserting information representing a sequence number of the voice packet.

4. The transmission method as claimed in claim 1, wherein the radio link control layer distinguishes the voice data part and the header part of the voice packet using the information assigned to the type field and assigns a value used for performing error detection with respect to the header part as information used for checking errors of the voice packet to be delivered to the lower layer.

5. The transmission method as claimed in claim 1, wherein, in the step of determining the coverage used for performing the error detection, when the received voice packet is concatenated with a previous voice packet which is not transmitted, the coverage is determined only for the received voice packet.

6. The transmission method as claimed in claim 1, wherein, in the step of generating the header, the header is generated by inserting an indicator representing that the voice packet is concatenated and transmitted.

7. A reception method for efficiently processing a voice packet in a mobile communication system providing a voice service through a packet network, the reception method comprising the steps of:
receiving by a radio link control layer data from a lower layer and reconstructing a voice packet by using a header including information representing a packet type of the data and information used for checking an error with respect to the header of the data;
extracting the information used in order to check an error in the header from the voice packet reconstructed by using the header;
confirming a voice data part of the voice packet using the information representing the packet type and determining an error detection range required for determining if an error exists in a part excluding the confirmed voice data part; and
determining if an error exists in the voice packet by comparing the error detection range with the information used for checking an error.

8. The reception method as claimed in claim 1, wherein, in the step of determining the error detection range, when the voice packet of the received data is concatenated with a voice packet of previous data (which are not transmitted), the error detection range is determined only for the voice packet of the received data.

9. A transmission apparatus for a radio link control which efficiently processes a voice packet in a mobile communication system providing a voice service through a packet network, the transmission apparatus comprises:
a buffer for receiving information representing a type of a voice packet and the voice packet from an upper layer and storing the information and the voice packet;
a division/concatenation module for performing division or concatenation with respect to the voice packet stored in the buffer and previously-received another voice packet such that the voice packet and another voice packet have sizes suitable for transmission through a wireless channel;
a header generating module for generating a header including information representing a sequence number used for distinguishing the voice packet and another voice packet, information representing a length of the voice packet, and information representing if errors exist in the header of the voice packet; and
an error information coverage determining module for distinguishing a voice data part and a header part of the voice packet using information representing the type and determining an error occurring range of the voice packet by assigning a value used for performing error detection for the header part as information used for checking errors with respect to the voice packet.

10. The transmission apparatus as claimed in claim 9, wherein, in the header generating module, an indicator representing that the received voice packet is concatenated and transmitted is further included.

11. A reception apparatus for radio link control which efficiently processes a voice packet in a mobile communication system providing a voice service through a packet network, the reception apparatus comprising:
a buffer for receiving data from a lower layer and storing the data;
a header extracting module for extracting information representing a type of the data and information representing if errors exist in a header of the data from the received data;
an error detection range calculating module for determining a voice data part of the data using the information representing the type and determining an error detection range used for determining if errors exist in a part excluding the determined voice data part; and
an error information comparison module for determining if errors exist in the header by comparing an error occurring range predetermined based on the type information with the information representing if errors exist in the header of the data.
